(19) United States
(12) Patent Application Publication
(10) Pub. No.: US 2005/0144604 A1
(43) Pub. Date: Jun. 30, 2005

(54) Methods and apparatus for software value prediction

(76) Inventors: Xiao Feng Li, Beijing (CN); Zhao Hui Du, Shanghai (CN); Tin-Fook Ngai, Santa Clara, CA (US)

Correspondence Address: HANLEY, FLIGHT & ZIMMERMAN, LLC, 20 N. WACKER DRIVE, SUITE 4220, CHICAGO, IL, 60606, US

(21) Appl. No.: 10/817,098

(22) Filed: Apr. 2, 2004

Related U.S. Application Data
(63) Continuation-in-part of application No. 10/749,490, filed on Dec. 30, 2003, now abandoned.

(51) Int. Cl. G06F 9/45

(52) U.S. Cl. 717/154

(57) ABSTRACT

Methods and apparatus to predict software values are disclosed. In one example, a method identifies a variable associated with one or more machine readable instructions, determines a predicted value of the variable based on a pattern, generates a value prediction instruction to predict a run-time value using the predicted value of the variable based on the pattern, and combines the value prediction instruction with the one or more machine readable instructions.

### RELATED APPLICATION

This application is a continuation-in-part of U.S. patent application Ser. No. 10/749,490, entitled “Methods and Apparatus for Software Value Prediction”, and filed on Dec. 30, 2003.

### TECHNICAL FIELD

The present disclosure is directed generally to software optimizations and, more particularly, to methods and apparatus to predict software values to reduce software execution times.

### BACKGROUND

Consumers continue to demand faster computers. To increase software execution speeds, many recent efforts have been directed to the development of compiler optimization and parallel threading techniques. Data dependencies often significantly limit the amount of parallelism that compiler optimization and/or parallel threading techniques can employ when optimizing and/or executing software applications. In general, a data dependency results when a first instruction cannot be executed before a second instruction because the first instruction uses an output or result (e.g., a variable or operand value) of the second instruction.

Value prediction is a well-known technique that may be used to break data dependencies and to enable portions of code that would otherwise have to be executed in a particular order to be executed in another order (e.g., in parallel). In some known value prediction systems, the execution order of a first instruction having an operand value and a second instruction requiring the operand value from the first instruction may be changed by predicting the operand value prior to completion of execution of the first instruction. As a result, the dependency relationship between the first and second instructions can be removed (e.g., broken) to enable substantially parallel execution of the first and second instructions, execution of the second instruction prior to execution of the first instruction, etc. If the predicted operand values are correct, the result is a faster (e.g., parallel) execution of the previously dependent instructions and the software of which the previously dependent instructions are a component.

However, known value prediction systems typically use expensive value prediction hardware and/or software emulation of value prediction hardware to predict operand values and the like during program execution. Although hardware-based value prediction boosts throughput performance, the hardware and/or hardware emulation software required is dedicated, expensive, and has limited flexibility, and extensibility.

### BRIEF DESCRIPTION OF THE DRAWINGS

FIG. 1 is a block diagram of an example processor system with which the example methods and apparatus disclosed herein may be implemented.

FIG. 2 is a flow diagram of an example process for predicting software values.

FIG. 3 is a flow diagram of an example process for creating new value predicting software.

FIG. 4 is a flow diagram of an example implementation of the process for predicting software values of FIG. 2.

FIG. 5 is a pseudo code representation of an example code block or software prior to the software value prediction.

FIG. 6 is a pseudo code representation of the example code block of FIG. 5 subsequent to the software value prediction.

FIG. 7 is a pseudo code representation of an example code block or software prior to software value prediction.

FIG. 8 is a pseudo code representation of the example code block of FIG. 7 subsequent to the software value prediction.

FIG. 9 is a pseudo code-based representation of the example code block of FIG. 7 during execution.

FIG. 10 is a pseudo code-based representation of the example code block of FIG. 8 during execution.

### DETAILED DESCRIPTION

The following describes example methods, apparatus, and articles of manufacture that provide a code execution system having the ability to predict software values. While the following disclosure describes systems implemented using software or firmware executed by hardware, those having ordinary skill in the art will readily recognize that the disclosed systems could be implemented exclusively in hardware through the use of one or more custom circuits, such as, for example, application-specific integrated circuits (ASICs) or any other suitable combination of hardware and/or software.

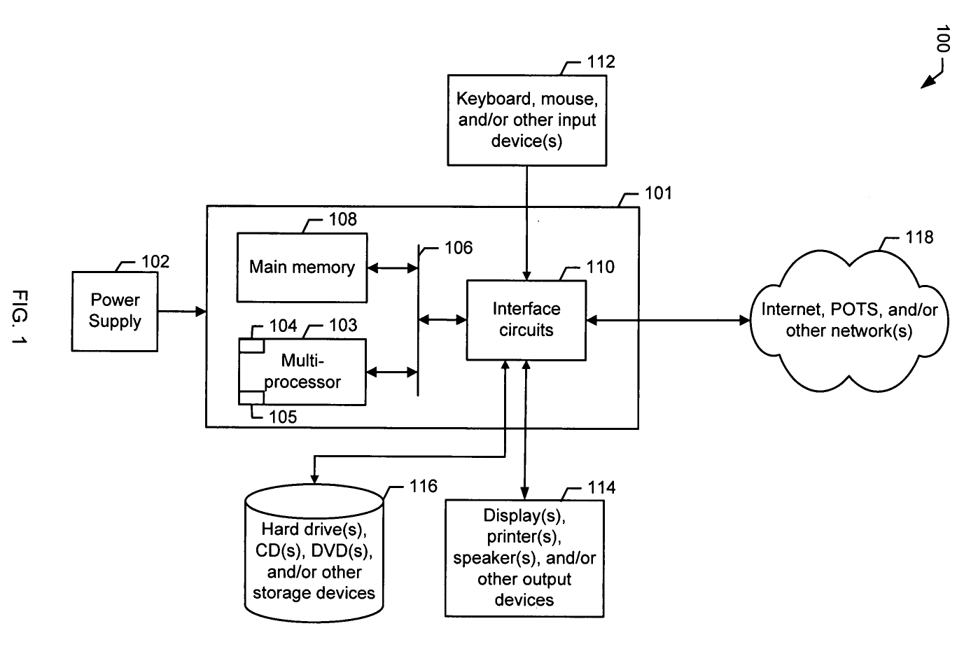

A block diagram of a computer system 100 that may implement the example processes described herein is illustrated in FIG. 1. The computer system 100 may be a server, a personal computer (PC), a personal digital assistant (PDA), an Internet appliance, a cellular telephone, or any other computing device. In one example, the computer system 100 includes a main processing unit 101 powered by a power supply 102. The main processing unit 101 may include a multi-processor 103 electrically coupled by a system interconnect 106 to a main memory device 108 and to one or more interface circuits 110. In one example, the system interconnect 106 is an address/data bus. Of course, a person of ordinary skill in the art will readily appreciate that interconnects other than busses may be used to connect the multi-processor 103 to the main memory device 108. For example, one or more dedicated lines and/or a crossbar may be used to connect the multi-processor 103 to the main memory device 108.

The multi-processor 103 may include one or more of any type of well-known processor, such as a processor from the Intel Pentium® family of microprocessors, the Intel Itanium® family of microprocessors, and/or the Intel XScale® family of processors. In addition, the multi-processor 103 may include any type of well-known cache memory, such as static random access memory (SRAM) and may include a first processor 104 and a second processor 105.

The first processor 104 may include any type of well-known processor, such as a processor from the Intel Pentium® family of microprocessors, the Intel Itanium® family of microprocessors, and/or the Intel XScale® family of processors.

The second processor 105 may include any type of well-known processor, such as a processor from the Intel Pentium® family of microprocessors, the Intel Itanium® family of microprocessors, and/or the Intel XScale® family of processors. The second processor 105 may include hardware and/or additional circuitry that support execution of speculative threads and along with the first processor 104 may provide thread-level speculation support, including data dependence checking and the re-execution of an incorrectly speculated calculation. For example, if a speculation is incorrect (i.e., some dependencies are violated), the associated speculative execution results may be deleted and the computation may be re-executed by the second processor 105.

The main memory device 108 may include dynamic random access memory (DRAM) and/or any other form of random access memory. For example, the main memory device 108 may include double data rate random access memory (DDRAM). The main memory device 108 may also include non-volatile memory. In one example, the main memory device 108 stores a software program which is executed by the multi-processor 103 in a well-known manner. The main memory device 108 may store one or more compiler programs, one or more software programs, and/or any other suitable program capable of being executed by the multi-processor 103.

The interface circuit(s) 110 may be implemented using any type of well-known interface standard, such as an Ethernet interface and/or a Universal Serial Bus (USB) interface. One or more input devices 112 may be connected to the interface circuits 110 for entering data and commands into the main processing unit 101. For example, an input device 112 may be a keyboard, mouse, touch screen, track pad, track ball, isopoint, and/or a voice recognition system.

One or more displays, printers, speakers, and/or other output devices 114 may also be connected to the main processing unit 101 via one or more of the interface circuits 110. The display 114 may be a cathode ray tube (CRT), a liquid crystal display (LCD), or any other type of display. The display 114 may generate visual indications of data generated during operation of the main processing unit 101. The visual indications may include prompts for human operator input, calculated values, detected data, etc.

The computer system 100 may also include one or more storage devices 116. For example, the computer system 100 may include one or more hard drives, a compact disk (CD) drive, a digital versatile disk drive (DVD), and/or other computer media input/output (I/O) devices.

The computer system 100 may also exchange data with other devices via a connection to a network 118. The network connection may be any type of network connection, such as an Ethernet connection, digital subscriber line (DSL), telephone line, coaxial cable, etc. The network 118 may be any type of network, such as the Internet, a telephone network, a cable network, and/or a wireless network.

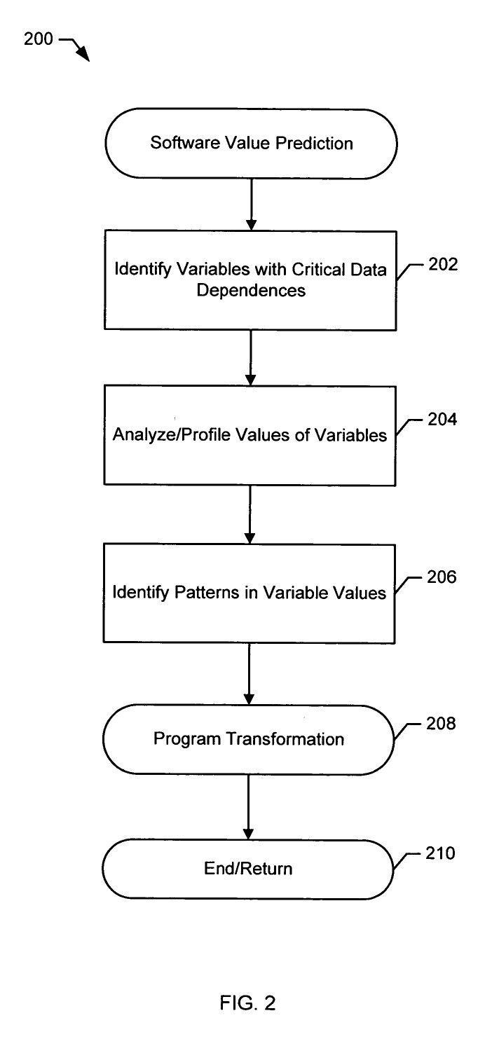

A software value prediction process 200, as shown in FIG. 2, may be implemented using one or more software programs or sets of instructions that are stored in one or more memories and executed by one or more processors. However, some or all of the software value prediction process 200 blocks may be performed manually and/or by some other device. Additionally, although the software value prediction process 200 is described with reference to the flow diagram illustrated in FIG. 2, persons of ordinary skill in the art will readily appreciate that many other methods of performing the software value prediction process 200 may be used. For example, the order of many of the blocks may be altered, the operation of one or more blocks may be changed, blocks may be combined, and/or blocks may be eliminated.

The software value prediction process 200 begins execution by identifying variables from one or more source files (e.g., software, sets of machine or processor executable instructions, etc.) with critical data dependencies (block 202). The identification of variables with critical data dependencies may be implemented by estimating the cost of misspeculation (i.e., incorrectly speculating) for each possible data dependency. For example, if a data dependency is likely to occur and the data dependency violation requires an expensive recovery, the data dependency is identified as critical and the corresponding piece of code is found to be especially beneficial for software value prediction as set forth in greater detail below. The cost or expense associated with recovery may be based on an amount of time required to re-execute code. Additionally or alternatively, the cost or expense associated with recovery may be based on the cost of delaying an application associated with the data dependency.

After identifying operands or variables with critical data dependencies (block 202), the software value prediction process 200 analyzes and/or profiles one or more values of the variables (block 204). As is known to those having ordinary skill in the art, profiling is a well-established technique that may include instrumenting the source program to monitor the values of a variable at specific points in the program (i.e., value profiling).

Besides value profiling, control-flow profiling may be used to analyze the possible values of a variable by determining which branch of a condition is normally taken during program execution. For example, in a source program containing:

```
int bar(void)
{
    if ( someCondition ) { x = 1; }
    else { x = 2; }
    return x;
}
```

If the first branch (i.e., the x=1; branch) is taken more often than the second branch (i.e., the x=2; branch), then a prediction may be made that the return value of the bar function is most often 1. The same value prediction can also be deduced from value analysis using control flow profiling which provides information associated with how often a branch statement is taken.

The analyzing and/or profiling of one or more values of the variables (block 204) may be implemented using one of these well-known profiling techniques, or any other desired technique.

After analyzing and/or profiling one or more values of the variables (block 204), the software value prediction process 200 identifies patterns in the values of the variables (block 206). The identification of the patterns may be implemented by comparing the values of the variables to built-in or predetermined patterns, representations of which may be stored in a memory (e.g., the memory 108, the storage devices 116, etc.). The predetermined patterns may include a constant pattern (i.e., a pattern that uses the most frequent value that appears in the sequence of values of the variable [e.g., pred_x=1, where 1 is the most frequently occurring value or the statistical mode]), a last-value pattern (i.e., a pattern that compares a value with its preceding value in the sequence [e.g., pred_x=last_x, where last_x is the previous value of x]), a constant-stride pattern (i.e., a pattern that compares a value with the preceding value plus a constant [i.e., a stride value], and uses the most frequent stride value [e.g., pred_x=pred_x+1, where the most frequent stride value is 1]), or any other suitable pattern.

In addition to identifying variable or operand value patterns, the software value prediction process 200 may also calculate the prediction accuracies of each pattern. For example, during the pattern matching, as described above, a prediction accuracy calculation for each of the predetermined patterns (e.g., a calculation for the constant pattern, a calculation for the last-value pattern, a calculation for the constant-stride pattern, etc.) may be implemented by code or instructions as set forth in the following example:
while (index<maximum_index){ if (x[index+1]=pred(x[index]))match_count++;}
The above example includes a variable index, which is an offset into an array x, a variable or a constant maximum_index, which is the size of the array x, a variable match_count, which counts the number of matches that the pattern (i.e., a pred function call instruction) has correctly predicted the next value. After the match_count value has been calculated, a ratio of the match_count to the total number of values collected minus one may be used to derive the accuracy of the predictor pattern for the variable value.

The accuracy of each predetermined pattern (e.g., the constant pattern, the last-value pattern, the constant-stride pattern, etc.) may be compared to determine which predetermined pattern to use. For example, if the constant pattern has an accuracy of 50% for an x variable and the constant-stride pattern has an accuracy of 90% for the x variable, the software value prediction process 200 may determine that the constant-stride pattern has a better accuracy and that the constant-stride pattern should therefore be used.

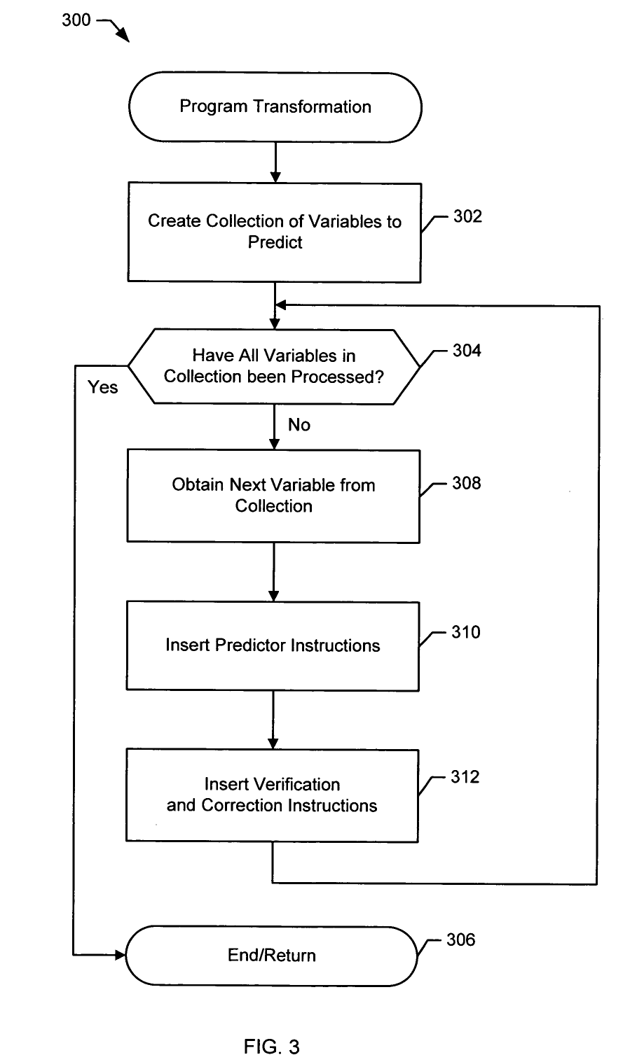

After identifying patterns associated with the values of the variables (block 206), the software value prediction process 200 invokes the program transformation process (block 208). The program transformation process is discussed in more detail below in conjunction with FIG. 3. After invoking the program transformation process (block 208), the software value prediction process 200 ends (block 210).

A program transformation process 300, as shown in FIG. 3, may be implemented using one or more software programs or sets of instructions that are stored in one or more memories and executed by one or more processors. However, some or all of the program transformation process 300 blocks may be performed manually and/or by some other device. Additionally, although the program transformation process 300 is described with reference to the flow diagram illustrated in FIG. 3, persons of ordinary skill in the art will readily appreciate that many other methods of performing the program transformation process 300 may be used. For example, the order of many of the blocks may be altered, the operation of one or more blocks may be changed, blocks may be combined, and/or blocks may be eliminated.

The program transformation process 300 begins by creating a collection of one or more variables to predict (block 302). The collection may be an array, a queue, a stack, a linked list, or any other suitable data structure. After creating the collection of one or more variables to predict (block 302), the program transformation process 300 determines if the collection contains a variable that has not yet been processed (block 304). If the program transformation process 300 determines that all variables in the collection have been processed (block 304), the program transformation process 300 ends (block 306).

On the other hand, if the program transformation process 300 determines that not all variables in the collection have been processed (block 304), the program transformation process 300 obtains the next variable from the collection (block 308). The next variable may be, for example, a pointer, a pointer to a structure, a reference to a class, etc. For example, if the collection is an array, the next variable may be obtained by incrementing an index to the array and reading the next variable from the index location.

After obtaining the next variable from the collection (block 308), the program transformation process 300 inserts one or more predictor instructions (i.e., predictor code) into a target program (block 310). The predictor code may be executed to perform a method of predicting the next value of the variable given the current and/or another past value of the variable. The predictor code may be a function call, a macro, an inline instruction, or any other programming construct.

The target program may be one or more files, and/or one or more intermediate representations stored in memory (e.g., the main memory device 108) containing instructions written in a high-level language, such as C/C++, Java, NET, practical extraction and reporting language (Perl), or any other suitable high-level language, low-level language, or intermediate representation.

After inserting the predictor code into the target program (block 310), the program transformation process 300 inserts one or more verification and correction instructions into the target program (block 312). The verification and correction instructions may be executed to perform a method of verifying that the value of the variable is correct and, if necessary, correcting the value of an incorrectly predicted variable using the correct value of the incorrectly predicted variable. The verification and correction instructions may be a function call, a macro, an inline instruction, or any other programming construct. After inserting one or more verification and correction instructions into the target program (block 312), the program transformation process 300 loops back to block 304.

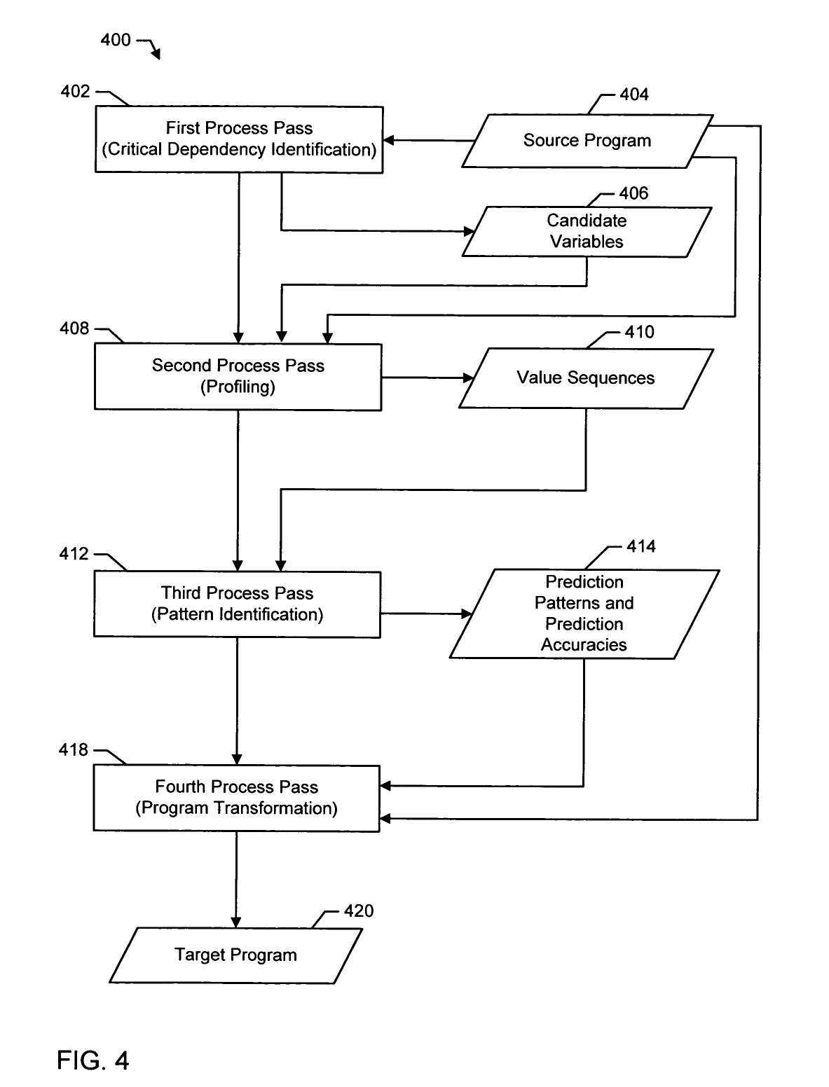

FIG. 4 illustrates a flow diagram of an example implementation 400 of the process for predicting software values of FIG. 2. The example implementation 400 may be embodied in one or more software programs, which are stored in one or more memories and executed by one or more processors in a well-known manner. The example implementation 400 includes a first process pass 402, one or more source programs 404, one or more candidate variables 406, a second process pass 408, one or more value sequences 410, a third process pass 412, one or more prediction patterns and one or more prediction accuracies 414, a fourth process pass 418, and one or more target programs 420. As is known to those having ordinary skill in the art, the first process pass 402, the second process pass 408, the third process pass 412, and the fourth process pass 418 (i.e., a plurality of process passes) may be implemented as one or more compiler executions, one or more software programs, or any other suitable process.

The plurality of process passes is typically initiated by a user, such as a software programmer. The example implementation 400 also involves a plurality of input and/or output entities 404, 406, 410, 414, and 420 that may be used by the process passes and may be implemented using one or more files and/or one or more internal representations stored in memory (e.g., the main memory 108).

As described in greater detail below, the example implementation 400 transforms the source programs 404, which are typically manually written by a software programmer and/or are machine generated, into the target programs 420 through the process passes and through the use and transformation of the intermediate input and/or output entities 406, 410, 414, and 420.

The first process pass 402 receives as an input the source programs 404 for which software value prediction is desired. The first process pass 402 then creates the candidate variables 406 that may include variables from the source programs 404. The method for accomplishing the first process pass 402 may be similar or identical to the critical data dependency identification method used in block 202 of FIG. 2.

The candidate variables 406 and the source program 404 are then used as inputs to the second process pass 408, which creates the value sequences 410. The value sequences 410 may include the candidate variables and a sequence of run-time values of the candidate variables. While the number of values to be collected typically depends on the application, an example number of values may be 1,000 values. The method for accomplishing the second process pass 408 may be similar or identical to the value profiling described in the variable value profiling/analysis method used in block 204 of FIG. 2.

The value sequences 410 are then used as an input to the third process pass 412, which creates the prediction patterns and the prediction accuracies 414. The prediction patterns 414 may include instructions for predicting values of the candidate variables. The prediction accuracies 414 may include accuracy information associated with the degree of predictability of each of the corresponding candidate variables. The accuracy information may be stored in the form of percentages or any other suitable format. Alternatively, the prediction patterns and the prediction accuracies 414 may be combined into one or more prediction accuracy and prediction pattern entity (i.e., file or internal representation). The method for accomplishing the third process pass 412 may be similar or identical to the pattern identification method used in block 206 of FIG. 2.

The fourth process pass 418 selectively transforms the inputs (i.e., the prediction patterns and the prediction accuracies 414, and the source programs 404) into the respective target programs 420. The target programs 420 may be similar or identical to the target programs described above in conjunction with FIG. 3. The method for accomplishing the fourth process pass 418 may be similar or identical to the program transformation method used in block 208 of FIG. 2.

Those having ordinary skill in the art will recognize that any method of generating the information represented by the target programs 420 may be utilized, and that the actions 402, 408, 412, and 418 depicted in FIG. 4 are provided for illustrative purposes only.

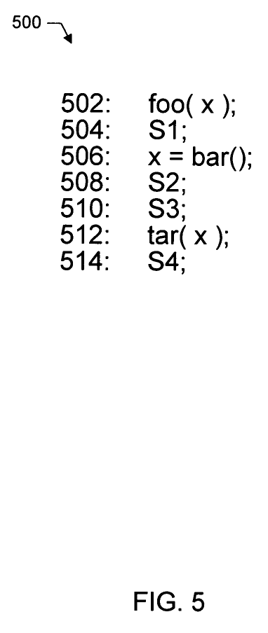

FIG. 5 is a pseudo code representation of an example code block or software 500 prior to the software value prediction. The pre-software value prediction code block 500 includes a plurality of instructions (generally shown as 502, 504, 506, 508, 510, 512, and 514). The pre-software value prediction code block 500 includes three function call instructions (i.e., the foo function call instruction 502, the bar function call instruction 506, the tar function call instruction 512) and four instructions between the function call instructions, (i.e., the S1 instruction 504, the S2 instruction 508, the S3 instruction 510, and the S4 instruction 514).

In the pre-software value prediction code block 500, the tar function call instruction 512 passes an x variable to a tar function. The value of the x variable is defined by the return value of the bar function call instruction 506. Suppose, the pre-software value prediction code block 500 has a critical data dependency between the tar function call instruction 512, which reads the x variable, and the bar function call instruction 506, which sets the x variable. Before applying software value prediction, the critical data dependency results in a fixed order of execution that can not be broken by conventional compilation techniques (e.g., the bar function call instruction 506 must be executed before the tar function call instruction 512).

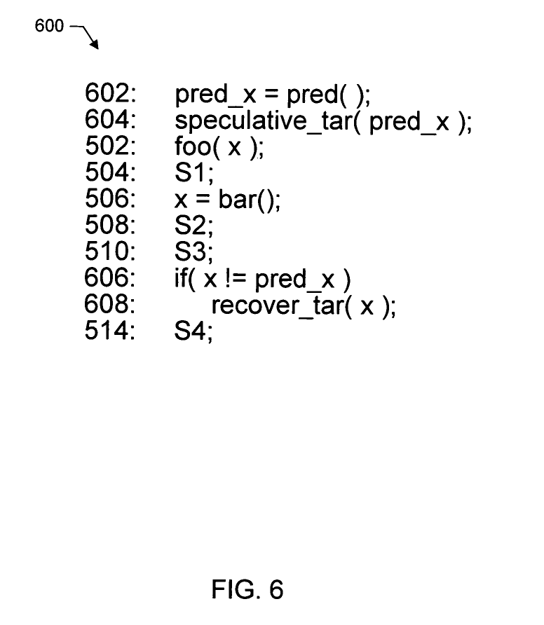

FIG. 6 is an example pseudo code representation of the example code of FIG. 5 subsequent to the software value prediction 600. The example post-software value prediction code block 600 is the pre-software value prediction code block 500 of FIG. 5 after being processed by the software value prediction process 200 of FIG. 2. The example post-software value prediction code block 600 includes a pred function call instruction 602, a verification instruction 606, and a correction instruction 608. If the pred function call instruction 602 does not result in a correct value in the pred_x variable (i.e., the x variable returned by the bar function call instruction 506 does not match the pred_x variable), the verification instruction 606 will detect the mismatch and will execute the correction instruction 608. In FIG. 6, the value prediction allows a speculative-execution version of the tar function call instruction 604 to be executed in parallel or before the foo function call instruction 502 and the bar function call instruction 506 resulting in more flexible scheduling of the instructions or optimizations of the program.

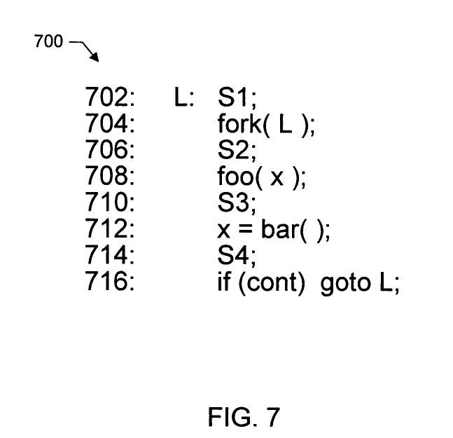

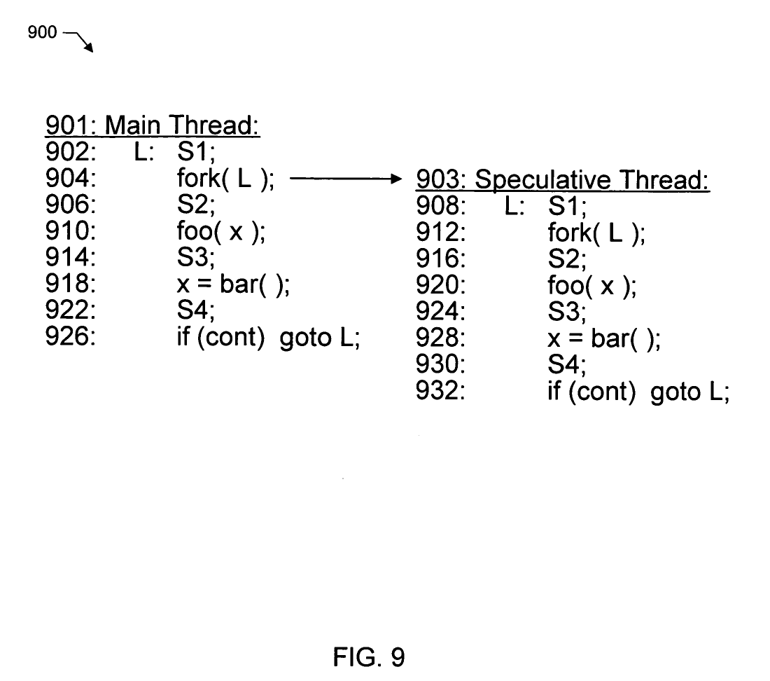

FIG. 7 is a pseudo code representation of an example code block or software 700 prior to software value prediction. The code block 700 includes an S1 instruction 702 that includes a label L, a fork function call instruction 704, an S2 instruction 706, a foo function call instruction 708, an S3 instruction 710, a bar function call instruction 712, an S4 instruction 714, and a conditional goto L instruction 716. Unlike the examples of FIGS. 5 and 6, the code block 700 is an example illustrating speculative parallel threading. The fork function call instruction 704 creates a new speculative parallel thread as discussed in greater detail below in conjunction with FIG. 9.

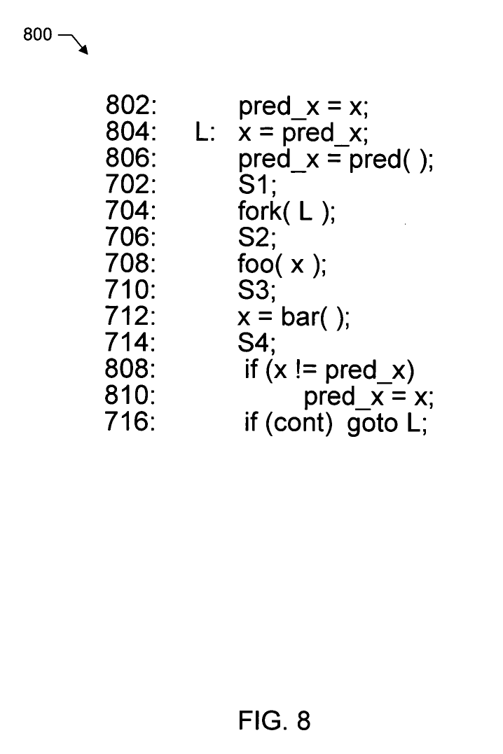

FIG. 8 is an example pseudo code representation of the example code block 700 of FIG. 7 subsequent to the software value prediction 800. The example code block 800 is the code block 700 of FIG. 7 after being processed by the software value prediction process 200. The example code block 800 includes a pred_x variable assignment instruction 802, an x variable assignment instruction 804, a pred function call instruction 806, a verification instruction 808, and a correction instruction 810. If the pred function call instruction 806 does not result in a correct value of the pred_x variable (i.e., the x variable returned by the bar function call instruction 712 does not match the pred_x variable), the verification instruction 808 will detect the mismatch and execute the correction instruction 810.

FIG. 9 is a pseudo code-based representation of the example code block 700 of FIG. 7 during execution 900. The program execution 900 includes a main thread 901 that is executing instructions on a processor (e.g., the first processor 104 of FIG. 1). For example, the main thread 901 may execute an S1 instruction 902, which includes a label L, before the creation of a new speculative parallel thread 903 that executes on a processor (e.g., the second processor 105 of FIG. 1) by invoking a fork function call instruction 904. The fork function call instruction 904 indicates that the new speculative parallel thread 903 will start executing the next iteration at the label L. The main thread 901 and the new speculative parallel thread 903 are copies of the code block 700 executing in parallel.

When the new speculative thread 903 is created (i.e., spawned) by the fork function call instruction 904, the new speculative thread 903 inherits the program state of the main thread 901 and may utilize shared memory locations with the main thread 901. The new speculative thread 903 reads the same memory variables, regardless of whether the memory variables are global variables or stack variables. The second processor 105 of FIG. 1 may also copy any registers (e.g., any registers holding the values of the variables x and pred_x during execution) used by the main thread 901 to the registers located within the second processor 105 used by the new speculative thread 903 upon the issuing of the fork function call instruction 904.

The program execution 900 includes an S2 instruction 906, an S1 instruction 908, a foo function call instruction 910, a fork function call instruction 912, an S3 instruction 914, an S2 instruction 916, a bar function call instruction 918, a foo function call instruction 920, an S4 instruction 922, an S3 instruction 924, a conditional goto L instruction 926, a bar function call instruction 928, an S4 instruction 930, and a conditional goto L instruction 932. The order of execution of the main thread 901 and the speculative thread 903 may be determined by timing and/or configuration of the program execution 900. The fork function call instruction 912 may cause the new speculative thread 903 to spawn a second speculative thread within the second processor 105, which is not illustrated here for reasons of simplicity. After executing the conditional goto L instructions 926 and/or 932, the program execution 900 may loop back to the label L at 902 and/or 908 depending on the value of the cont variable.

The x value produced in a first iteration of the main thread 901 by the result of the bar function call instruction 918 executing in the main thread 901 is used by the foo function call instruction 910 in a second iteration of the main thread 901 . This is a critical dependence between the first and second iterations. Without software value prediction, the execution of the new speculative thread 903 uses a stale value of the x variable (i.e., the value of the x variable at the time of the fork function call instruction 904) and the results of the speculative thread 903 will be incorrect, which requires the results to be flushed, and the second iteration will need to be re-executed. If the value of the x variable for the second iteration is highly predictable, the foo function call instruction 920 can be speculatively executed with the predicted value and the speculative thread 903 can then generate correct results most of the time, typically leading to successful parallel thread execution.

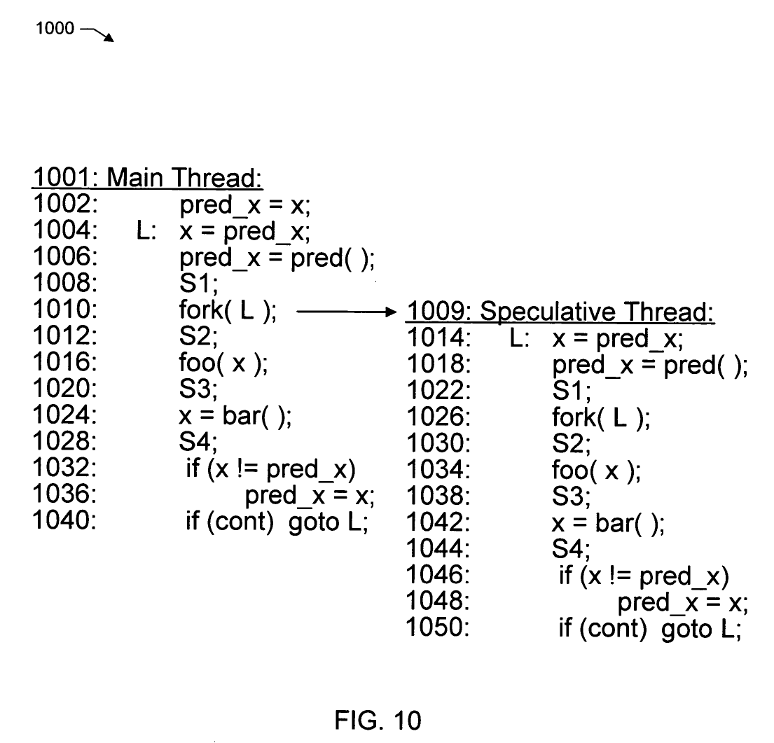

FIG. 10 is a pseudo code-based representation of the example code block of FIG. 8 during execution 1000. The program execution 1000 implements the value predictor of the x variable as a pred function call instruction 1006 and uses the pred function call instruction to compute the predicted value of the x variable (i.e., the pred_x variable), before a fork function call instruction 1010 that spawns a new speculative thread 1009 on a processor (i.e., the second processor 105). The new speculative thread 1009 then uses the pred_x variable as the x variable initial value by executing an x assignment instruction 1014. If the program execution 1000 predicts the wrong value, the post-program execution 1000 detects the miscalculation at a verification instruction 1032. Because the value of the pred_x variable is different from the pred_x variable used in the speculative thread 1009, the second processor 105 will be triggered to re-execute the next iteration.

The memory writes associated with the new speculative thread 1009 are speculative and typically cannot modify the memory of the main thread 1001 before a commit. The memory writes of the new speculative thread 1009 must be buffered and not seen by the main thread 1001. The main thread 1001 executes normally in the sequential execution.

While FIGS. 5, 6, 7, 8, 9 and 10 are referred to as functions, the code blocks 500, 600, 700, 800, 900, and 1000 may be alternatively implemented using a macro, a constructor, a plurality of inline instructions, or any other programming construct.

Although certain apparatus, methods, and articles of manufacture have been described herein, the scope of coverage of this patent is not limited thereto. On the contrary, this patent covers every apparatus, method and article of manufacture fairly falling within the scope of the appended claims either literally or under the doctrine of equivalents.

1. A method comprising:
identifying a variable associated with one or more machine readable instructions;
determining a predicted value of the variable based on a pattern;
using the predicted value of the variable based on the pattern to generate a value prediction instruction to predict a run-time value; and
combining the value prediction instruction with the one or more machine readable instructions.

2. A method as defined in claim 1, further comprising:
determining if the run-time value matches the predicted value; and
generating a value correction instruction to correct the run-time value if the run-time value does not match the predicted value.

3. A method as defined in claim 2, further comprising combining the value correction instruction with the one or more machine readable instructions to be executed subsequent to an invocation of a speculative parallel thread.

4. A method as defined in claim 1, further comprising combining the value prediction instruction with the one or more machine readable instructions to be executed prior to an invocation of a speculative parallel thread.

5. A method as defined in claim 1, wherein the variable is associated with a data dependency.

6. A method as defined in claim 1, wherein the one or more machine readable instructions comprises an internal representation.

7. A method as defined in claim 1, wherein the one or more machine readable instructions comprises a source code file.

8. A method as defined in claim 6, wherein the source code file comprises a high-level instruction.

9. A method as defined in claim 1, wherein the pattern comprises a predetermined pattern.

10. A method as defined in claim 9, wherein the predetermined pattern comprises at least one of a constant pattern, a last-value pattern, and a constant-stride pattern.

11. A method as defined in claim 10, wherein the constant pattern is based on a most frequently occurring value.

12. A method as defined in claim 1, wherein the predicted value is created by a profiling technique.

13. An apparatus comprising:
a memory; and
a processor coupled to the memory and configured to:
identify a variable associated with one or more machine readable instructions;
determine a predicted value of the variable based on a pattern;
use the predicted value of the variable based on the pattern to generate a value prediction instruction to predict a run-time value; and
combine the value prediction instruction with the one or more machine readable instructions.

14. An apparatus as defined in claim 13, wherein the processor is further configured to:
determine if the run-time value matches the predicted value; and
generate a value correction instruction to correct the run-time value if the run-time value does not match the predicted value.

15. An apparatus as defined in claim 14, wherein the processor is further configured to combine the value correction instruction with the one or more machine readable instructions to be executed subsequent to an invocation of a speculative parallel thread.

16. An apparatus as defined in claim 13, wherein the processor is further configured to combine the value prediction instruction with the one or more machine readable instructions to be executed prior to an invocation of a speculative parallel thread.

17. An apparatus as defined in claim 13, wherein the variable is associated with a data dependency.

18. An apparatus as defined in claim 13, wherein the one or more machine readable instructions comprises an internal representation.

19. An apparatus as defined in claim 13, wherein the one or more machine readable instructions comprises a source code file.

20. An apparatus as defined in claim 18, wherein the source code file comprises a high-level instruction.

21. An apparatus as defined in claim 13, wherein the pattern comprises a predetermined pattern.

22. An apparatus as defined in claim 21, wherein the predetermined pattern comprises at least one of a constant pattern, a last-value pattern, and a constant-stride pattern.

23. An apparatus as defined in claim 22, wherein the constant pattern is based on a most frequently occurring value.

24. An apparatus as defined in claim 13, wherein the predicted value is created by a profiling technique.

25. A machine readable medium having instructions stored thereon that, when executed, cause a machine to:
identify a variable associated with one or more machine readable instructions;
determine a predicted value of the variable based on a pattern;
use the predicted value of the variable based on the pattern to generate a value prediction instruction to predict a run-time value; and
combine the value prediction instruction with the one or more machine readable instructions.

26. A machine readable medium as defined in claim 25, having instructions stored thereon that, when executed, cause the machine to:
determine if the run-time value matches the predicted value; and
generate a value correction instruction to correct the run-time value if the run-time value does not match the predicted value.

27. A machine readable medium as defined in claim 26, having instructions stored thereon that, when executed, cause the machine to combine the value correction instruction with the one or more machine readable instructions to be executed subsequent to an invocation of a speculative parallel thread.

28. A machine readable medium as defined in claim 25, having instructions stored thereon that, when executed, cause the machine to combine the value prediction instruction with the one or more machine readable instructions to be executed prior to an invocation of a speculative parallel thread.

29. A machine readable medium as defined in claim 25, wherein the variable is associated with a data dependency.

30. A machine readable medium as defined in claim 25, wherein the one or more machine readable instructions comprises an internal representation.

31. A machine readable medium as defined in claim 25, wherein the one or more machine readable instructions comprises a source code file.

32. A machine readable medium as defined in claim 30, wherein the source code file comprises a high-level instruction.

33. A machine readable medium as defined in claim 25, wherein the pattern comprises a predetermined pattern.

34. A machine readable medium as defined in claim 33, wherein the predetermined pattern comprises at least one of a constant pattern, a last-value pattern, and a constant-stride pattern.

35. A machine readable medium as defined in claim 34, wherein the constant pattern is based on a most frequently occurring value.

36. A machine readable medium as defined in claim 25, wherein the predicted value is created by a profiling technique.
